(19) United States
(12) Patent Application Publication
(10) Pub. No.: US 2026/0309329 A1
(43) Pub. Date: Oct. 8, 2026

(54) DEVICE AND METHOD FOR INJECTING A HYDROGEN-AIR MIXTURE FOR A TURBINE ENGINE BURNER

(71) Applicant: SAFRAN, PARIS (FR)

(72) Inventors: Stéphan ZURBACH, MOISSY-CRAMAYEL (FR); Romain LE DORTZ, MOISSY-CRAMAYEL (FR)

(21) Appl. No.: 19/108,234

(22) PCT Filed: Aug. 25, 2023
(86) PCT No.: PCT/FR2023/051299

§ 371 Date: Mar. 3, 2025

(30) Foreign Application Priority Data
Sep. 5, 2022 (FR) FR2208857

(51) Int. Cl. F23R 3/34; B64D 27/10; F23C 6/02; F23R 3/28

(52) U.S. Cl. CPC F23R 3/346; B64D 27/10; F23C 6/02; F23R 3/286; F23C 2900/9901

(57) ABSTRACT

A device for injecting a combustible mixture into a combustion chamber of a turbine of an aircraft turbine engine which has, about a longitudinal axis, a tubular central channel, a first annular channel about the central channel, and a second annular channel about the first annular channel, the channels being open to the combustion chamber at a first lip of the central channel, at a second lip of the first annular channel, and at an end of the second annular channel. The first annular channel includes, upstream of the second lip, a device for injecting dihydrogen into the first annular channel in an air flow passing along the longitudinal axis of the first annular channel so as to create a dihydrogen-air mixture flowing towards the combustion chamber.

### CROSS REFERENCE TO RELATED APPLICATIONS

This application is a US National Phase Application of PCT/FR2023/051299 filed Aug. 25, 2023, which claims priority to French Patent Application No. 2208857 filed Sep. 5, 2022, both of which are hereby incorporated by reference in their entirety.

### TECHNICAL FIELD

This disclosure relates to the field of injection devices and methods for feeding to gas turbines such as aircraft turbine engines powered by dihydrogen and air. This specifically includes civil and military aeronautical applications: helicopters, VTOLs, drones, APUs, turbo generators, fixed-wing aircraft for leisure, business or commercial aviation, turbojets, or turboprops.

### BACKGROUND

The propulsion sectors, and in particular the aeronautics sector, are facing major environmental challenges. There is increasingly strong interest in combustion which uses dihydrogen rather than kerosene, because dihydrogen combustion would avoid pollutant carbon emissions such as carbon dioxide, carbon monoxide, unburned hydrocarbons, or fine particles and smoke.

The principle of burners based on a micromix combustion of air and dihydrogen is known. Burners implemented according to this principle do not guarantee the absence of flashback in the dihydrogen injection device, and have a complex geometry. Such burners have a high production cost, a high pressure drop, and are specific to a given combustion chamber architecture.

In the injection and combustion, there exist two main technological configurations for hydrogen-air injection systems applied to gas turbines, namely lean injection systems and rich injection systems.

More generally, it is important to keep in mind that lean combustion fueling processes tend to generate significant thermoacoustic instabilities that can damage these systems, while stable combustion is necessary to avoid altering engine performance. As for rich combustion fueling processes, these tend to emit more pollutants than lean combustion processes if they are not properly sized.

The use of hydrogen means there are several issues to be taken into consideration at the combustion chamber:

At equivalent thermodynamic conditions for the pressure, temperature, and injection richness, the adiabatic temperature of the flame in hydrogen-air combustion is higher than that of the flame in kerosene-air combustion. However, the flammability limits for hydrogen cover a wider range than those for kerosene and allow the mixture to be ignited at lower or higher richnesses than kerosene, which could ultimately allow lower flame temperatures than with the use of kerosene.

Similarly, the flame speeds from hydrogen-air combustion are higher than for kerosene-air flames. A high flame speed can lead to flashback problems in injection systems, particularly at the boundary layers, and can cause serious damage to these systems.

Lastly, the combustion of hydrogen with air tends to emit much more noise than conventional kerosene combustion, and can therefore generate significant noise pollution at airports in the case of aeronautical use.

There is therefore a desire to reduce combustion temperatures, reduce sound waves from combustion, and limit the formation of nitrogen oxides, in order to reduce both noise pollution and air pollution during the operation of turbines.

For the burners, documents GB2502298A and U.S. Pat. No. 6,267,585 describe chamber geometries based on the principle of a micromix burner. This type of burner is designed to miniaturize the reaction zone by creating a multitude of micro-diffusion flames of up to 4 cm long. The combustion process is based on injecting hydrogen perpendicular to an air flow that carries the hydrogen (known as jet-in-crossflow). Once the rapid addition of hydrogen to the air has been achieved, the mixture is injected into the combustion chamber and burned downstream of a multitude of injection holes. This technology reduces the risk of flashback because there is no premixing before injection. The operability of this type of injector may be limited, as well as the thermal resistance of the wall containing the injection holes which is subjected to high temperature conditions.

In the context of burners using kerosene, the document “Advanced Combustor Systems for Stationary Gas Turbine Engines, Phase I. Review and Preliminary Evaluation, Volume I”, S. A. Mosier, R. M. Pierce, Contract 68-02-2136, FR-11405, Final Report, U.S. Environmental Protection Agency, 1980, proposes an RQL geometry, this being the acronym used in the field for “Rich Burn-Quick Mix-Lean Burn”.

This geometry aims to stage the richness in the kerosene combustion chamber into several zones: a first zone close to the injector outlet where the richness is approximately 1.8, followed by a second zone for very intense mixing with air where the aim is to minimize the formation of stoichiometric regions and the formation of NOx and to complete the rich combustion upstream. Finally, in order to cool the combustion gases upstream of the “High Pressure Distributor” HPD, additional injections of air are planned in a third zone in order to carry out a second lean combustion at richness 0.5. Due to the specificity of hydrogen, an RQL geometry that is optimized for kerosene combustion is no longer valid and must be redesigned.

### SUMMARY

To do so, this disclosure relates to a device for injecting a combustible dihydrogen-air mixture, for the combustion chamber of a turbine engine, intended for staging the combustion in order to limit the generation of NOx and limit the noise emitted by the combustion. This disclosure further relates to an associated injection method.

More specifically, this disclosure proposes a device for injecting a combustible mixture, for a combustion chamber of a turbine of an aircraft turbine engine, which comprises, about a longitudinal axis, a tubular central channel, a first annular channel about the central channel, and a second annular channel about the first annular channel, the channels being configured so as to be open to the combustion chamber at a first lip of the central channel, at a second lip of the first annular channel, and at an end of the second annular channel, the first annular channel comprising, upstream of the second lip, means for injecting dihydrogen into the first annular channel in an air flow moving along the longitudinal axis of the first annular channel so as to produce a dihydrogen-air mixture flowing between the first lip and the second lip.

The first lip may be arranged upstream of the end of the second annular channel, the central channel being open to the combustion chamber at the first lip, upstream of the end of the second annular channel.

The second lip may be arranged upstream of the end of the second annular channel, the first annular channel being open to the combustion chamber at the second lip, upstream of the end of the second annular channel.

The central channel may be provided with a first swirler for rotating a gas passing through it.

The second annular channel may be provided with a second swirler for rotating a gas passing through it.

Said means for injecting dihydrogen advantageously comprise a plurality of first radial conduits between an external wall of said first annular channel and an annular pipe for supplying said conduits, said annular pipe being supplied by one or more second conduits that bring in dihydrogen.

This disclosure further relates to a method for feeding a hydrogen-air combustion in a combustion chamber of a turbine of an aircraft turbine engine, by means of an injection device as described above, which comprises injecting air into the combustion chamber via the tubular central channel, injecting dihydrogen and air into the combustion chamber via the first annular channel in order to form a dihydrogen-air premix, and injecting air into the combustion chamber via the second annular channel.

The dihydrogen-air premix advantageously has a dihydrogen richness that is greater than two.

The injection of air into the tubular central channel and into the second annular channel is an injection of pure air, targeting an overall injection richness of between 0.3 and 0.5.

In the case where the device comprises a first swirler in the tubular central channel, the air is rotated in the central channel by said first swirler.

In the case where the device comprises a second swirler in the second annular channel, the air is rotated in the second annular channel.

The method is advantageously such that, after ignition, the injection of the rich hydrogen-air premix creates a first flame front resulting from rich combustion of the hydrogen-air premix, which attaches to the lips of the tubular central channel and of the first annular channel, this rich combustion with a richness greater than two being carried out with a flame front temperature of less than 1800 K.

As a result, the noise generated by the first flame front is reduced and the formation of nitrogen oxides is reduced.

Advantageously, the injection of air from the tubular central channel and from the second annular channel dilutes and confines the burnt gases resulting from combustion of the rich hydrogen-oxygen premix, to form a lean mixture creating a second flame front from lean combustion at a temperature of less than 1800 K.

As a result, the noise generated by the second flame front is similarly reduced and the formation of nitrogen oxides is also reduced.

The creation of these two flame fronts, rich and lean, makes it possible to distribute the thermoacoustic load resulting from combustion over a larger surface area, and therefore to reduce the noise pollution resulting from the combustion.

Preferably, said second flame front is turbulent and is not attached to said lips.

### BRIEF DESCRIPTION OF DRAWINGS

Other features, details and advantages will become apparent upon reading the detailed description below, and upon analyzing the attached drawings, in which:

FIG. 1 shows a schematic longitudinal section view of an injection device according to one embodiment;

FIG. 2 shows a schematic cross-section view of means for supplying an annular channel according to a first embodiment;

FIG. 3 shows the device of FIG. 1, with flame fronts;

FIG. 4A shows a cross-section of a variant of the means for supplying an annular channel according to a second embodiment;

FIG. 4B shows a longitudinal section view of the means of FIG. 4A.

FIG. 5 shows a schematic longitudinal section view of an injection device according to another embodiment.

### DESCRIPTION OF EMBODIMENTS

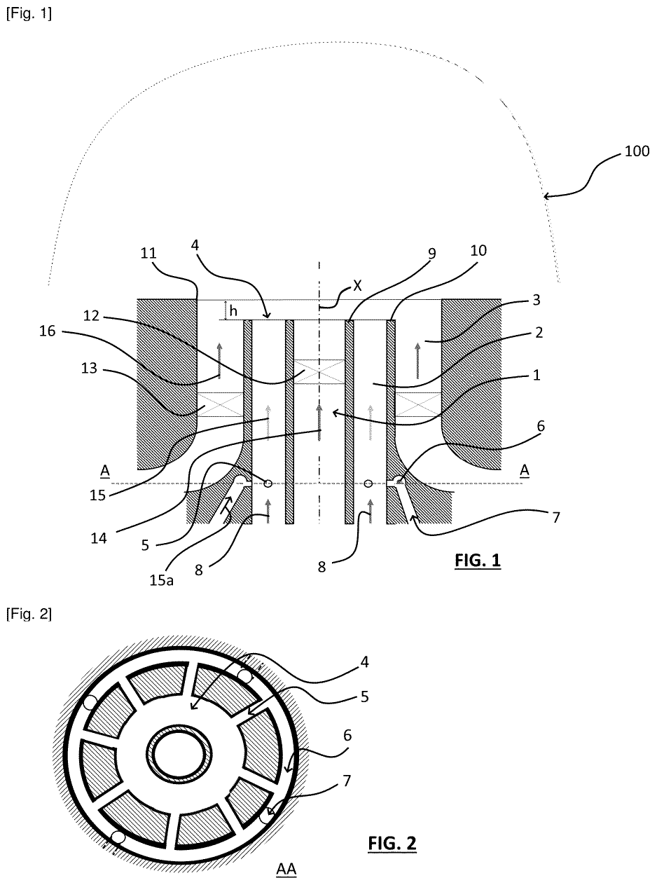

Reference is now made to FIG. 1, which shows a section view of a device for injecting a combustible mixture implemented according to the principle of this disclosure, in a plane comprising a longitudinal axis X of the device.

The device comprises a tubular central channel 1 centered on axis X, a first annular channel 2 around said tubular central channel, and a second annular channel 3 around first annular channel 2.

Channels 1, 2, 3 are open to a combustion chamber 100. The tubular central channel comprises a first circular lip 9 surrounded by the first annular channel at an outlet plane 4 of said central channel, the first annular channel comprising a second circular lip 10 again at outlet plane 4. The second circular lip is surrounded by the second annular channel and the first lip and second lip are set back by a height h relative to the plane of outlet 11 of the second annular channel. Thus the outlets of the tubular central channel and of the first annular channel are upstream of the outlet of the second annular channel.

The first annular channel comprises, upstream of second lip 10, means for injecting dihydrogen into an air flow 8 moving along the longitudinal axis, so as to produce a dihydrogen-air mixture flowing towards the combustion chamber. To inject the dihydrogen, the means for injecting dihydrogen comprises radial conduits 5, shown in a section view in FIG. 2, which lead to the external wall of first annular channel 2. To clarify, the ratio of the distance to the outlet and the diameter of first channel 2 may be between 1 and 10, more preferably between 1 and 5.

In FIG. 2, the injections of dihydrogen are “jet-in-crossflow” injections, i.e. radial injections of dihydrogen into an axial jet of air, in order to obtain a rapid premix, over a minimized axial length, of the dihydrogen-air premix 15 exiting first annular channel 2.

These radial conduits are supplied, according to the example, by an annular tube 6 which itself is supplied by one or more second conduits 7 that bring in dihydrogen from a pressurized tank or a pump, not shown. The number of first conduits is for example from 10 to 20 and is for example about 16 for a good dihydrogen distribution.

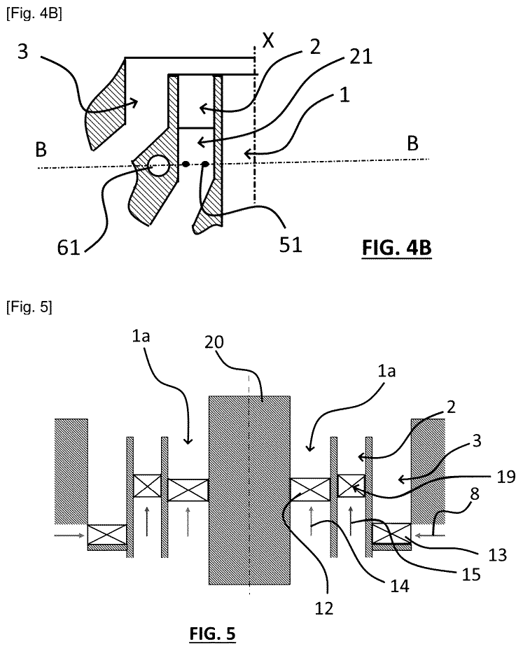

As a variant, according to FIG. 4A and FIG. 4B which are, respectively, a cross section and a longitudinal section to one side of axis X of the device, the means for dihydrogen injection comprise first conduits 51 supplied via an annular tube 61 through sub-conduits 52, but the dihydrogen is mixed with air in hollow sectors 21 supplying the first annular channel from below, at the other end of said channel relative to its outlet into the combustion chamber. In this example, conduits 51 each supply two sectors.

According to this example, four hollow sectors, each supplied by four first conduits 51 in which the mixture of dihydrogen-air is carried out, are present under first annular channel 2.

According to this embodiment, the injection process is improved by the addition of an air rotation device 8 (swirler), consisting of several hollow blades, four blades in FIG. 4A, in which the dihydrogen circulates. The dihydrogen is injected by jet-in-crossflow injections 51 into the blades of the swirler, to optimize the mixing process.

The device of this disclosure allows staged combustion of hydrogen in order to bypass the zone of nitrogen oxide formation via combustion of a rich hydrogen-air premix in a first zone, and combustion of the residual gases in a second lean zone. The concept of staged combustion allows a wider range of injector operability than a strategy oriented towards lean combustion hydrogen injection where a lean premix is directly burned in the chamber, and aims to reduce NOx formation.

The risk of flashback is limited with rich combustion, because diffusive-thermal instabilities are not present in the first flame front. The flame speed is thus not accelerated by the instabilities. In addition, richness staging avoids the formation of a stoichiometric flame front, because the hydrogen is either a rich premix or is vitiated by combustion gases. This has the effect of reducing the speed of the flame front, which is highly dependent on the composition of the gases to be burned.

The stabilization of two flame fronts 17 and 18, front 17 attached to lips 9 and 10 of the injector for the rich flame and front 18 detached for the lean flame, makes it possible to divide the thermoacoustic loads linked to combustion: the noise generated by combustion is distributed over two flame fronts, i.e. over a larger surface area than in the case where a single flame front is generated.

The integrity of the injector is also ensured because, by carrying out combustion at high and low richnesses, the flame temperatures are lower than when carrying out combustion under stoichiometric conditions. The potential flame fronts from the stoichiometric zones that could be present will not be attached to the lips of the injector, thus reducing damage to the injector.

By significantly increasing the surface area of the flame front via injection of the rich hydrogen-air premix into first annular channel 2, the length of the flame is reduced, which makes it possible to produce combustion chambers of reduced size compared to injection into a central tubular channel.

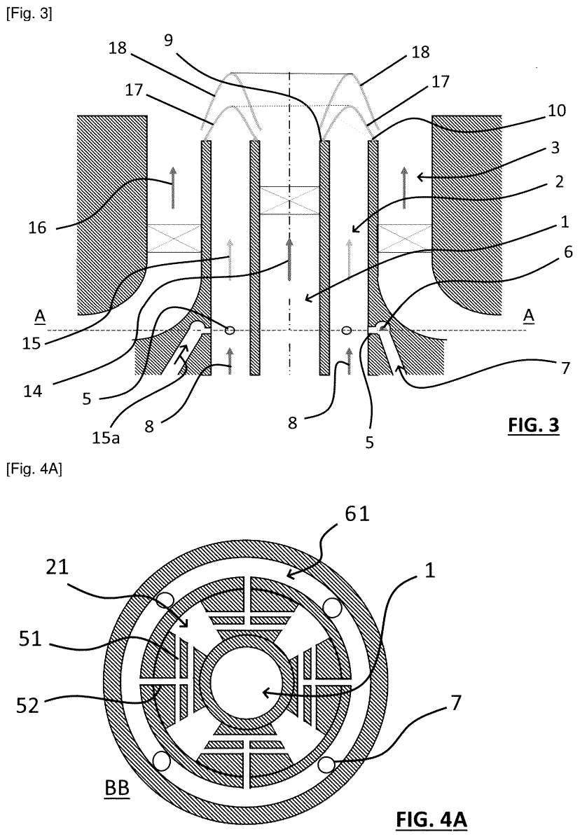

With reference to FIGS. 3 and 4B, in order to promote the interaction between the air in channel 16 and premix flame 17, lip 10 is set back relative to the end of the second annular channel, this setback denoted h in FIG. 1, to improve the interaction between jet 16 exiting the second annular channel and jet 15 exiting the first annular channel.

In the context of operating under the typical conditions of a turboprop, the richness of the rich zone may in particular be fixed at around 4, and the overall richness fixed between 0.17 and 0.31 depending on the operating points of the turboprop.

The size of such a device for a combustion chamber of a turbine of an aircraft turboprop is about 30 mm to 40 mm.

FIG. 5 shows a variant of the injection system, applied to the assembly that includes the bottom of the aeronautical combustion chamber with a shaft in the center where tubular central channel 1a is composed of a third annular channel about shaft 20, each of the channels being provided with a swirler 12, 13, 19, the annular flame fronts surrounding shaft 20.

This disclosure thus concerns a tri-coaxial system for injecting hydrogen pre-mixed with air, for an aeronautical or terrestrial gas turbine, based on staged combustion:
a. Combustion of the hydrogen-air premix at high richness takes place in a first region which generates a first annular flame front attached to lips 9, 10 of the injector, first inner lip 9 and second outer lip 10 of the annular channel for injecting the dihydrogen-air mixture;
b. The combustion products are then rapidly mixed via the central and peripheral injection of air, to be burned in a second region, generating a second unattached flame front.

The system makes it possible in particular:
a. to obtain aerodynamically stabilized flames over a wide operating range,
b. to achieve combustion with very low nitrogen oxide emissions,
c. to avoid the risk of flashback of the second flame front,
d. to reduce the noise pollution linked to hydrogen combustion,
e. to obtain short flames with a distribution of thermal loads,
f. to improve the integrity and service life of the injector.

The device of the invention is thus associated with a method for feeding a hydrogen-air combustion in a combustion chamber of a turbine of an aircraft turbine engine which comprises: injecting air 14 into the chamber via tubular central channel 1, injecting dihydrogen 15a and air 8 into the chamber via first annular channel 2 to form a dihydrogen-air premix 5, and injecting air 16 into said chamber via second annular channel 3.

Dihydrogen-air premix 15 may then have a dihydrogen richness greater than two, while the injection of air 14 into tubular central channel 1 and into second annular channel 3 is an injection of pure air calibrated to target an overall injection richness of between 0.3 and 0.5.

According to the example of FIG. 3, the device comprising a first swirler 12 in tubular central channel 1, air 14 is rotated in central channel 1 by this first swirler, while, the device comprising a second swirler 13 in the second annular channel, air 4 is rotated in the second annular channel.

After ignition, injection of rich hydrogen-air premix 15 creates a first flame front 17, this flame resulting from rich combustion of the hydrogen-air premix which attaches to lips 9 and 10 of tubular central channel 1 and of first annular channel 2.

This rich combustion, with a richness greater than two, is carried out with a flame front temperature that is below 1800 K, reducing NOx emissions. The injection of air from tubular central channel 1 and from second annular channel 3 dilutes and confines the burnt gases from combustion of the rich hydrogen-oxygen premix, to form a lean mixture creating a second lean combustion flame front 18 at a temperature below 1800K, also reducing NOx emissions. Second flame front 18, which is also turbulent, is not attached to lips 9, 10 of tubular central channel 1 and of first annular channel 2.

The device and method of this disclosure are efficient, while limiting NOx emissions.

The invention which is the subject of the following claims is not limited to the preceding description, and in particular the shape of the lips and of the outlet of the second annular channel may be of various shapes such as straight, flared, beveled, narrowing, and of various thicknesses.

1. An injection device for injecting a combustible air-dihydrogen mixture, for a combustion chamber (100) of a turbine of an aircraft turbine engine, characterized in that it comprises, about a longitudinal axis (X), a tubular central channel (1), a first annular channel (2) about the central channel, and a second annular channel (3) about the first annular channel (2), the channels (1, 2, 3) being configured so as to be open to the combustion chamber at a first lip (9) of the central channel, at a second lip (10) of the first annular channel, and at an end (11) of the second annular channel, the first annular channel comprising, upstream of the second lip (10), means for injecting dihydrogen (5, 6, 7) into the first annular channel (2) in an air flow (8) moving along the longitudinal axis of the first annular channel so as to produce a dihydrogen-air mixture flowing between the first lip and the second lip.

2. The injection device according to claim 1, wherein the first lip (9) is arranged upstream of the end of the second annular channel, the central channel (1) being open to the combustion chamber (100) at the first lip (9), upstream of the end (11) of the second annular channel, and/or wherein the second lip (10) is arranged upstream of the end of the second annular channel, the first annular channel being open to the combustion chamber at the second lip (10), upstream of the end (11) of the second annular channel.

3. The injection device according to claim 1, wherein the central channel (1) is provided with a first swirler (12) for rotating a gas passing through it.

4. The injection device according to claim 1, wherein the second annular channel (3) is provided with a second swirler (13) for rotating the gas passing through it.

5. The injection device according to claim 1, wherein said means for injecting dihydrogen (5, 6, 7) comprise a plurality of first conduits (5, 51) between an external wall of said first annular channel (2) and an annular pipe (6, 61) for supplying said conduits, said annular pipe being supplied by one or more second conduits (7) that bring in dihydrogen.

6. A method for feeding a hydrogen-air combustion in a combustion chamber of a turbine of an aircraft turbine engine, by means of the injection device according to claim 1, comprising injecting air (14) into said combustion chamber via said tubular central channel (1), injecting dihydrogen (15a) and air (8) into said combustion chamber via the first annular channel (2) in order to form a dihydrogen-air premix (15), and injecting air (16) into said combustion chamber via the second annular channel (3).

7. The method for feeding a hydrogen-air combustion according to claim 6, wherein the dihydrogen-air premix (15) has a dihydrogen richness that is greater than two.

8. The method for feeding a hydrogen-air combustion according to claim 7, wherein the injection of air (14) into the tubular central channel (1) and into the second annular channel (3) is an injection of pure air, targeting an overall injection richness of between 0.3 and 0.5.

9. The method for feeding a hydrogen-air combustion according to claim 6, wherein, said injection device comprising a first swirler (12) in the tubular central channel, the air (14) is rotated in the central channel (1) by said first swirler, and/or wherein, said injection device comprising a second swirler (13) in the second annular channel, the air (4) is rotated in the second annular channel.

10. The method for feeding a hydrogen-air combustion according to claim 6, wherein, after ignition, the injection of the dihydrogen-air premix (15) creates a first flame front (17) resulting from rich combustion of the hydrogen-air premix, which attaches to the lips (9, 10) of the tubular central channel (1) and of the first annular channel (2), this rich combustion with a richness greater than two being carried out with a flame front temperature of less than 1800 K, and wherein the injection of air from the tubular central channel (1) and from the second annular channel (3) dilutes and confines the burnt gases resulting from combustion of the rich hydrogen-oxygen premix, to form a lean mixture creating a second flame front (18) from lean combustion at a temperature of less than 1800 K, said second flame front (18) being turbulent and not being attached to said lips (9, 10).
